(19) United States
(12) Patent Application Publication
(10) Pub. No.: US 2010/0232748 A1
(43) Pub. Date: Sep. 16, 2010

(54) OPTOELECTRONIC TRANSCEIVER ASSEMBLY

(75) Inventor: Ke ZENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/609,143

(22) Filed: Oct. 30, 2009

(30) Foreign Application Priority Data
Mar. 13, 2009 (CN) 200920301248.6

(51) Int. Cl. G02B 6/36

(52) U.S. Cl. 385/88

(57) ABSTRACT

An optoelectronic transceiver includes a base, a printed circuit board (PCB) fixed to the base, and a cover. The base includes a bottom plate, a pair of sidewalls and a spacer defining a fastener hole and extending perpendicularly from the bottom plate. Each of the pair of sidewalls defines a notch. The cover includes a pair of latch blocks engageable with the notches and defines a hole opposite the fastener hole of the base. The cover is fixed to the base via the pair of latch blocks engaging the notches of the base and a fastener engaging the fastener hole by way of the hole.

### BACKGROUND

1. Technical Field

The present disclosure relates to optoelectronic transceivers, and in particular to a shell of an optoelectronic transceiver assembly.

2. Description of Related Art

Diodes are basic components used in an optical transceiver. Often, an optoelectronic transceiver assembly includes a photoelectric diode and a laser emitter respectively receiving and sending optically encoded data. The photoelectric diode and the laser emitter are soldered on a printed circuit board (PCB), which is positioned on a base of the optical transceiver. A cover is fixed to the base to protect the PCB, the photoelectric diode, and the laser emitter. Effective installation and securing of the cover to the base is important.

It is thus desirable to provide an optoelectronic transceiver assembly addressing the limitations described.

### BRIEF DESCRIPTION OF THE DRAWINGS

FIG. 1 is a perspective view of an optoelectronic transceiver assembly in accordance with one embodiment of the present disclosure.

FIG. 2 is an exploded perspective view of FIG. 1.

FIG. 3 is an enlarged, perspective view of “III” area shown in FIG. 2.

FIG. 4 is an enlarged, perspective view of “IV” area shown in FIG. 2.

FIG. 5 is a front view of a base of the optoelectronic transceiver assembly of FIG. 1.

### DETAILED DESCRIPTION

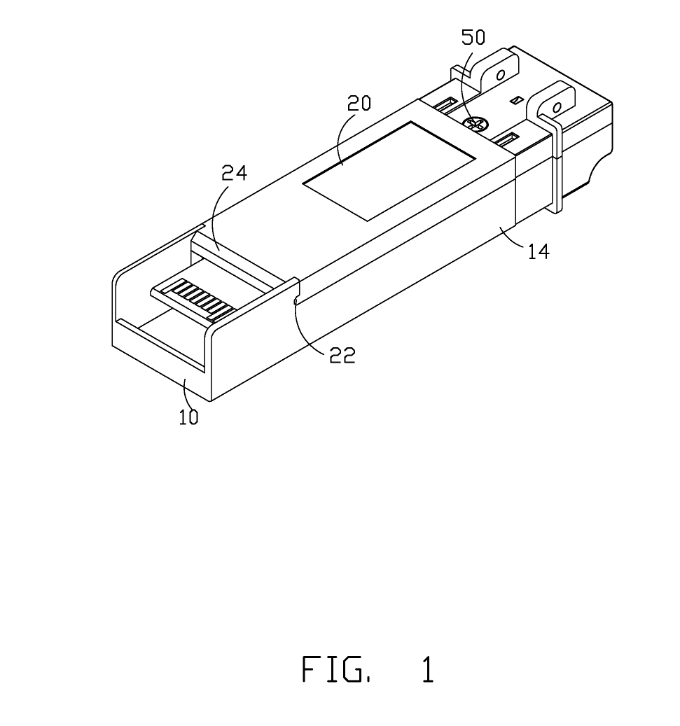

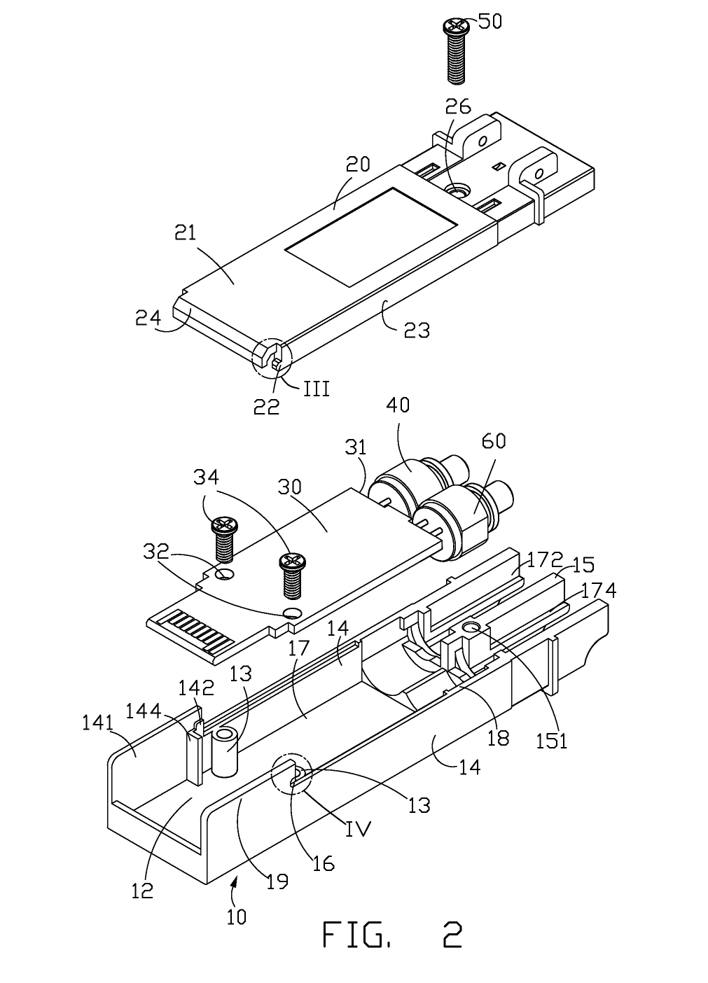

Referring to FIG. 1 and FIG. 2, an optoelectronic transceiver assembly according to one embodiment of the present disclosure includes a base 10 and a cover 20 fixed to the base 10. A printed circuit board (PCB) 30 configured with a photoelectric diode 40 and a laser emitter 60 is located on the top portions of the base 10 via one or more holes 32 defined in the PCB 30. In one example, the photoelectric diode 40 and the laser emitter 60 may be positioned on an edge 31 of the PCB 30. The positioning, in one embodiment, may use solder to position the photoelectric diode 40 and the laser emitter 60 on the edge 31.

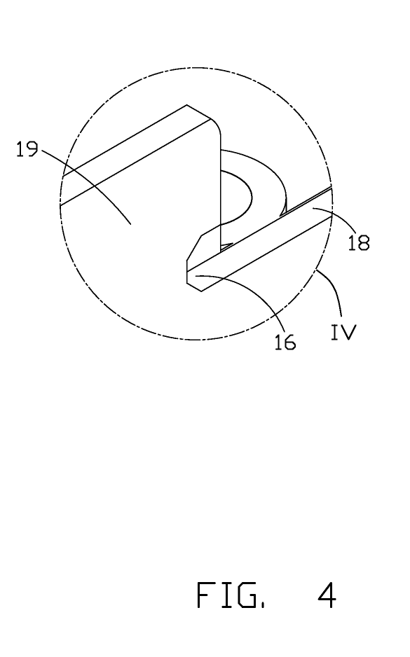

The base 10 includes a bottom plate 12 and a pair of sidewalls 14 extending from two opposite edges of the bottom plate 12. A spacer 15 defines a fastener hole 151 and extends perpendicularly from the bottom plate 12. The spacer 15 and the pair of sidewalls 14 collectively define two bays 172, 174. One or more hollow posts 13 extend perpendicularly from the bottom plate 12. The PCB 30 is fixed to the base 10 via one or more fasteners 34, such as screws, passing through the holes 32 of the PCB 30 and engaging the hollow posts 13, with the photoelectric diode 40 and the laser emitter 60 respectively received in the bays 172, 174. The pair of sidewalls 14 each includes a supporting plane 18 and a protrusion 19 projecting from the supporting plane 18. A pair of notches 16 is defined in the pair of sidewalls 14, respectively, and located where the supporting planes 18 and the protrusions 19 meet (shown in FIG. 4).

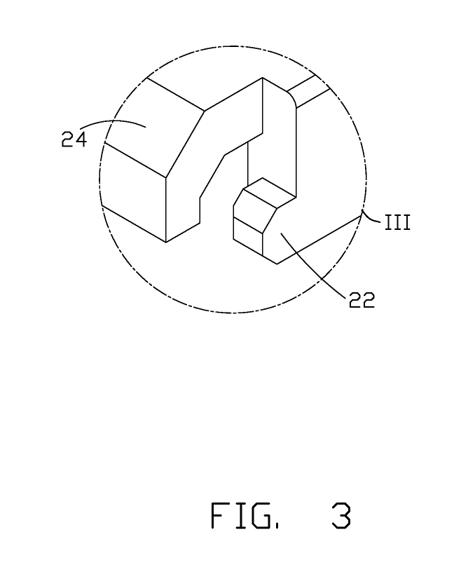

Referring to FIG. 3, the cover 20 includes a top plate 21 defining a hole 26, a pair of side plates 23, a pair of latch blocks 22 and an end portion 24. The pair of latch blocks 22, engageable with the notches 16, are formed on one end of the pair of side plates 23, respectively. The end portion 24 extends from one end of the top plate 21 between the pair of latch blocks 22.

During installation of the cover 20 to the base 10, the pair of side plates 23 of the cover 20 are supported on the pair of supporting planes 18 of the base 10, and the latch blocks 22 of the cover 20 engage the notches 16 of the base 10, and the cover 20 is fixed to the base via a fastener 50 engaging the fastener hole 151 of the base 10 by way of the hole 26.

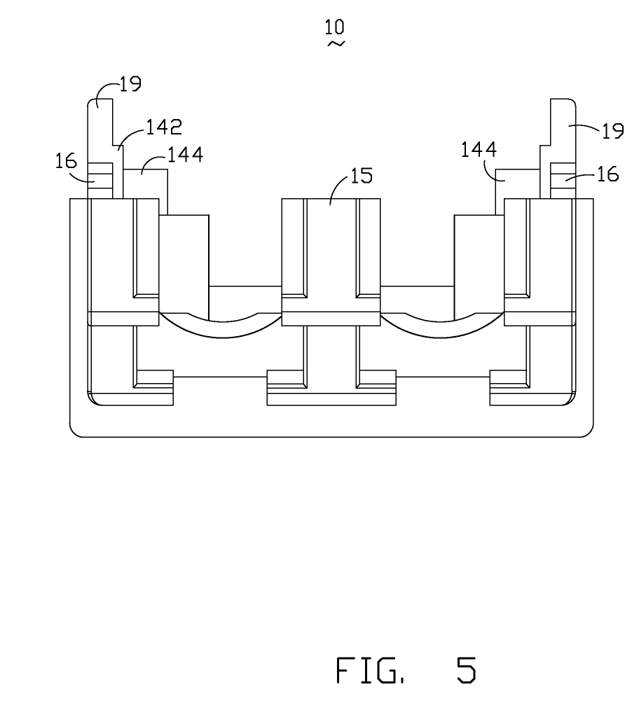

Referring to FIG. 5, in this embodiment, the base 10 further includes a pair of stopper portions 142 and at least one supporting post 144. The pair of stopper portions 142 abut an inner surface 141 of the sidewalls 14, respectively, to partition the notches 16 from an inner space 17 of the base 10. During installation of the cover 30 to the base 10, the pair of stopper portions 142 position cover 20 on the base 10 accurately. The supporting post 144 located between the pair of protrusions 19 is opposite to the end portion 24 of the cover 20, which is received thereon.

While exemplary embodiments have been described, it should be understood that they have been presented by way of example only and not by way of limitation. The breadth and scope of the disclosure should not be limited by the described exemplary embodiments, but only in accordance with the following claims and their equivalents.

What is claimed is:

1. An optoelectronic transceiver assembly, comprising:
a base, comprising a bottom plate, a pair of sidewalls extending from two opposite edges of the bottom plate and a spacer extending perpendicularly from the bottom plate and defining a fastener hole, wherein each of the pair of sidewalls defines a notch at a top portion thereof, and the spacer and the pair of sidewalls collectively define two bays;
a printed circuit board (PCB) located on the top portions of the pair of sidewalls and configured with a photoelectric diode and a laser emitter on an edge thereof, wherein the photoelectric diode and the laser emitter are respectively received in the two bays; and
a cover, comprising a pair of latch blocks engageable with the notches and defining a hole corresponding to the fastener hole in the spacer of the base;
wherein the cover is fixed to the base by the pair of latch blocks engaging the notches and a fastener engaging the fastener hole by way of the hole.

2. The optoelectronic transceiver assembly as claimed in claim 1, wherein the top portion of each of the sidewalls comprises a supporting plane from which a protrusion projects, and the notches are defined between the supporting planes and the protrusions.

3. The optoelectronic transceiver assembly as claimed in claim 2, wherein the cover comprises a top plate and a pair of side plates, the pair of side plates respectively supported on the pair of supporting planes of the base, and the pair of latch blocks are formed on one end of the pair of side plates, respectively.

4. The optoelectronic transceiver assembly as claimed in claim 3, wherein the base further comprises a pair of stopper portions abutting inner surfaces of the sidewalls, respectively, to partition the notches from an inner space of the base.

5. The optoelectronic transceiver assembly as claimed in claim 4, wherein the base further comprises at least one supporting post, the cover comprises an end portion extending from the top plate between the pair of latch blocks and on the at least one supporting post.

6. The optoelectronic transceiver assembly as claimed in claim 5, wherein the at least one supporting post is located between the pair of protrusions.
